(19) United States
(12) Patent Application Publication
(10) Pub. No.: US 2010/0186594 A1
(43) Pub. Date: Jul. 29, 2010

(54) SCENTED FURNACE FILTER

(76) Inventor: Dave Gelo, Waukon, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 12/360,982

(22) Filed: Jan. 28, 2009

(51) Int. Cl. B01D 46/42

(52) U.S. Cl. 96/222

(57) ABSTRACT

A scented furnace filter assembly. The scented furnace filter assembly comprises a frame that has a filter screen therein. A wick is installed inside of the frame and has a scent that emits therefrom wherein the wick is sealed until use. Once ready for use the seal is removed and the scent emits from the wick to provide scented air through a furnace and throughout a home or building.

### BACKGROUND OF THE INVENTION

This invention relates to furnace filters. More specifically this invention relates to a scented furnace filter.

Furnace filters have been used for many years. A typical furnace filter has a frame that encloses a screened or filtered portion that is placed into a furnace. As air is heated air flows through the furnace filter to capture any contaminates before being vented through conduits throughout a home or building.

In the past in order to attempt to provide a soothing scent to the air being conveyed throughout a home or building, individuals have placed certain scents on an air filter in the form of scented strips. However problems with these types of filter remain. Specifically the strips generally are thick and take up space making installing the filters difficult at times. Additionally the strips allow the scent to be emitted previous to being placed in the furnace causing the scent to be completely emitted before use occurs. Oftentimes the scent does not last for the same period of time that a filter is in use thus providing waste. Consequently a need in the art is presented for an improved scented filter.

Therefore a principal object of the present invention is to provide a scented furnace filter that improves upon the state of the art.

Yet another object of the present invention is to provide a scented furnace filter that efficiently emits a scent from a furnace filter.

These and other objects, features, or advantages of the present invention will become apparent from the specification and claims.

### SUMMARY OF THE INVENTION

A scented furnace filter assembly. The assembly includes an outer frame and a screen that is secured to and surrounded by the frame. The screen filters air blown through a furnace. A wick is installed inside of frame that has a scent that emits therefrom over a predetermined amount of time.

### BRIEF DESCRIPTION OF THE DRAWINGS

FIG. 1 is a front plan view of a scented furnace filter assembly; and

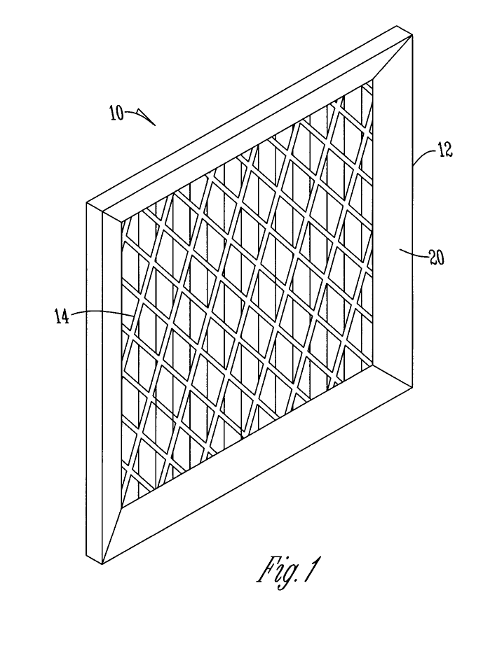

FIG. 2 is a back plan view of a scented furnace filter assembly.

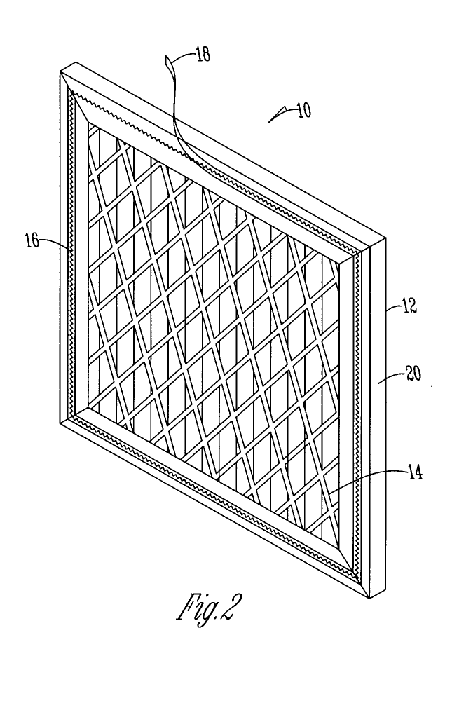

### DETAILED DESCRIPTION OF A PREFERRED EMBODIMENT OF THE INVENTION

The figures show a furnace filter assembly 10 that is placed into a furnace in order to filter air as is known in the art. The assembly 10 has an outer frame 12 and a screen 14 that is secured to and surrounded by the frame 12 for filtering air blown through a furnace. A wick 16 installed inside of frame 12 and has a scent emitting therefrom over a predetermined amount of time. A seal 18 removably encloses the wick to hold in the scent within the seal to prevent scent from escaping.

The outer frame 12 in a preferred embodiment has a rectangular outer perimeter but can be of any size and shape to accommodate the screen 14 to form a furnace filter 10. Specifically the outer frame 12 can vary in size as is known in the art to accommodate different sized furnaces.

In a preferred embodiment, outer frame 12 has a triangular outer surface 20 which defines an open internal space 22 (not pictured). Alternatively outer frame 12 can be of any shape, such as square, rectangular, octagonal, circular or the like, which defines an internal space 22 and provides support for the furnace filter 10. Preferably, the outer frame 12 is made of 1 layer of waxed cardboard which locks the scent inside the internal space 22. Alternatively, the outer frame 12 is made of any material which provides the necessary support for the furnace filter assembly 10 and locks the scent inside of the internal space 22 such as plastic, metal, rubber, composite or like materials.

The wick 16 is preferably installed inside the internal space 22 of frame 12 and extends around the entire perimeter of the outer frame 12. Extending the wick 16 around the entire perimeter of the outer frame 12 provides for the maximum amount of scent to be provided through the filter. In this embodiment, a portion of the wick 16 is in communication with the outer surface 20 of outer frame 12 such as by protruding through the outer surface 20 of frame 12. This exposure to the air allows scent on the wick 16, and locked within the internal space 22, to escape. In a preferred embodiment, the wick 16 protrudes through the frame 12 on the rear side of the filter to ensure that air flowing out of the filter is the air that is receiving and conveying the scent. In an alternative embodiment, wick 16 is secured to the external surface 20 of frame 12.

To prevent premature disbursement of the scent on wick 16, the portion of wick 16 which protrudes through the frame 12, or is connected to the external surface 20 of frame 12, is removably covered by seal 18. Preferably, seal 18 is comprised of the same material frame 12 is made of. Alternatively, seal 18 is any material that is removably attachable to the surface of frame 12 over wick 16 which is impermeable to scent such as waxed cardboard, plastic, plastic film, rubber, or like materials.

The wick 16 has properties wherein it can absorb scent and be easily installed inside internal space 22 or adjacent to the outer surface 20 or around the perimeter of the outer frame 12. In a preferred embodiment the predetermined amount of time that the wick 16 emits scent is thirty days. Thirty days is typically the time recommended for use of a furnace filter before replacement is recommended. Therefore the scent only lasts as long as the filter minimizing overuse of a scented material.

In operation an individual receives the assembly 10 and stores the assembly 10 until use is needed. Because of the seal 18 over the wick 16 the scent captured by the wick 16 is maintained until use is desired. At this time the seal 18 is removed and an individual places the filter assembly 10 within a furnace. The furnace then conveys scented air through vents and conduits throughout a house or building to provide a preferred scent.

As a result of use of the filter assembly 10 a manner in which scented air can be provided throughout a house or building is provided. By using a wick that is sealed no scent is lost during the storage process and by having the scent only last a predetermined amount of time the overall efficiency of the filter assembly 10 is maximized. Thus at the very least all of the stated objectives have been met.

It will be appreciated by those skilled in the art that other various modifications could be made to the device without the parting from the spirit and scope of this invention. All such modifications and changes fall within the scope of the claims and are intended to be covered thereby.

What is claimed is:

1. A scented furnace filter assembly comprising:
outer frame;
screen secured to and surrounded by the frame for filtering air blown through a furnace;
a wick secured to the outer frame and having a scent emitting therefrom during a predetermined amount of time.

2. The assembly of claim 1 wherein the wick is secured to an entire perimeter of the outer frame.

3. The assembly of claim 1 wherein the predetermined amount of time is thirty days.

4. The assembly of claim 1 further comprising a seal removably enclosing the wick to hold in the scent.
